(19) United States
(12) Patent Application Publication
(10) Pub. No.: US 2006/0156852 A1
(43) Pub. Date: Jul. 20, 2006

(54) Speed reducer for industrial robot

(76) Inventor: Kazuhiro Haniya, Fukuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/542,714

(22) PCT Filed: Jan. 21, 2004
(86) PCT No.: PCT/JP04/00464

§ 371 Date: Jul. 20, 2005

(30) Foreign Application Priority Data
Jan. 21, 2003 (JP) 2003-12824

(51) Int. Cl. B25J 18/00

(52) U.S. Cl. 74/490.03

(57) ABSTRACT

A problem of the invention is to provide a reduction device at low cost capable of considerably alleviating a restriction on a range of operating each shaft of a robot by providing a communication hole at a center portion and wiring a wire-like member therein while using a main bearing having an optimum load capacity. According to the invention, in a reduction device of a rotating shaft (first shaft) having a large gear a position of which is fixed to a robot base and a small gear brought in mesh with the large gear and axially supported in a rotating barrel portion, the large gear and the small gear are arranged at a vicinity of a rotational plane of a second shaft (front/rear shaft), further, in the reduction device of the rotating shaft (first shaft) having a small gear axially supported by a robot base and a large gear which is brought in mesh with the small gear and a position of which is fixed to a rotating barrel portion, a large gear and a small gear are arranged at a vicinity of the rotational plane of the second shaft (front/rear shaft).

### TECHNICAL FIELD

The present invention relates to a reduction device of an industrial robot.

### BACKGROUND ART

In a background art, a joint portion of an industrial robot (hereinafter, referred to as “robot”) is generally attached with a reduction device. There is a backlash as one of functions requested for the reduction device. A backlash refers to an interval between a pinion gear and a spur gear, attached to a shaft of a motor, where strange sound is emitted or friction is produced in case of said interval not optimum. Although when the backlash is large, the backlash constitutes a factor of deteriorating an operational locus accuracy or a positioning accuracy of a robot. On the other hand, without any backlash at all, a gear operated in a state of lack of the backlash is subjected to a bending stress larger than a value conceived in design and it is known that the gear is failed to be broken far earlier than desired service life. It is the most important problem to optimally maintain the backlash.

Hence, in order to normally rotate a pair of gears while maintaining a pertinent amount of a backlash, which might require a low backlash for a reduction device of a robot, a gear train is rarely adopted at a final reduction stage. As for calculating a pertinent amount of a backlash, it goes without saying that it is necessary to reduce a backlash amount by studying accuracy of a gear box, accuracy of a rotational bearing, thermal expansion or the like, however, it is also necessary to give a further consideration to a reduction in a backlash amount by elastic deformation of a main bearing caused by a reaction force when a robot is operated.

A moment operated to a robot will be explained in reference to FIG. 5 as follows.

In the drawing, a numerical reference 2 designates an upper arm AM, a numerical reference 3 designates a load, a numerical reference 84 designates a main bearing built in a reduction device mechanism, a numerical reference 100 designates a large gear, and a numerical reference 103 designates a small gear. Notation S designates a rotating shaft (first shaft), and a rotating head RH is horizontally rotated centering on the vertical shaft S. Notation L designates a front/rear shaft (second shaft) and a first arm AM1 is pivoted back and forth with centering on the horizontal shaft L. Notation U designates an up/down shaft (third shaft) and the second arm AM2 is pivoted up and down with centering on the horizontal shaft U.

When the robot is stationary, the main bearing 84, which is built in each reduction device mechanism, has a load such as by gravitational moment forces in accordance with positions or masses of the upper arm AM2 and the load 3.

Further, in a state of operating the robot, an inertia force or a centrifugal force might be generated which will be the load to the main bearing 84 as a dynamic moment in accordance with mass, acceleration, velocity or the like.

Further, when an interference with a peripheral jig is brought about, a force for generating a rotational torque constituted by a motor maximum torque multiplied by a gear ratio is applied to an interference point. Also an emergency moment in correspondence with the applying force is applied to the main bearing 84. As the main bearing 84, a pair of conical roller bearings or angular bearings having a high axial loading function are mainly used. The above-described moment applied to the main bearing 84 is applied as a radial load and an axial load. As a result, the main bearing 84 is elastically deformed and a radius direction backlash is changed by moving the large gear 100 and the small gear 103 between axes thereof.

Further, a circumferential direction backlash is changed by twisting the large gear 100 and the small gear 103 between the axes.

Although the robot can take an arbitrary attitude, a direction of the moment being applied can be predictable. The gravitational force moment applied to the main bearing 84 of the rotating shaft is always applied in a plane of rotating the front/rear shaft. Also the dynamic moment and the emergency moment are always applied in the plane of rotating the front/rear shaft when the front/rear shaft and the up/down shaft are applied. Although in the case of operating the rotating shaft and a wrist shaft, there is a case in which the dynamic moment is not applied in the plane of rotating the front/rear shaft, an absolute value thereof is small and is negligible in comparison with the dynamic moment in operating the front/rear shaft and the up/down shaft.

FIG. 6 is a side view showing a main work area of the robot.

As is known from the drawing, operation of the robot is normally carried out in the area as shown in FIG. 6, whereby normally the load such as the gravitational force moment is not applied to the main bearing of the front/rear shaft in view of an attitude of the operation. Further, in an operating state of the front/rear shaft and the up/down shaft, any dynamic moment or emergency moment might not be applied. It is in a state of operating the rotating shaft that a moment is generated in a rotating plane including the work area.

FIG. 7 illustrates a sectional view (a) and a perspective view (b) with regard to an arrangement of a small gear according to the invention.

Now, as shown by FIG. 7(b), in the case of arranging a small gear at a position a of an outer periphery of the large gear where a moment is applied in a direction orthogonal to a direction of connecting respective centers of the large gear and the small gear, a circumferential direction backlash jt is expressed as shown below when a width in an axial direction of a gear is designated by notation B (FIG. 7(a)) and an angle of falling the gear is designated by notation θ.
jt=Bsinθ (1)
The circumferential direction backlash is hence reduced by that amount. The fact shows that it is necessary to provide a circumferential direction backlash equal to or larger than the circumferential direction backlash jt to the gears in advance.

Next, as a function requested for the reduction device, it is pointed out that a hollow structure as shown by FIG. 8 described in Patent Reference 1 (Patent Reference 1: JP-A-10-175188) is required.

FIG. 8 is a sectional view of an essential portion according to a background art and according thereto, there is proposed a method of providing communication holes at the center portions of reduction devices of a first shaft and a third shaft where a wire-like member is arranged therein so as to alleviate a restriction placed to the operation ranges by the respective shafts of a robot considerably. A first shaft reduction device mechanism 12 is constituted by a large gear and a small gear both axially supported by a rotating barrel portion, and a rotating-type reduction device.

Further, as a publicly-known example of a rotating type reduction device, there is FIG. 9 illustrated in Patent Reference 2 (Patent Reference 2: JP-B-8-22516).

This is an example of including the main bearing 84, the main bearing needs to be arranged at outer peripheries of a crankshaft 30 and a needle bearing 42, whereby an outer diameter thereof is enlarged more than necessary. Further, when a hollow portion is provided thereto, it is necessary to adopt a bearing with a larger size, which ends up an increase in a weight thereof and an increase in cost. Further, in this example, if a moment is applied to the main bearing, a gear 29 performs an eccentric pivoting movement at each time of rotating the crankshaft 30 by one rotation. When a gear ratio of the gear 29 is set to 1/60, the gear 29 repeats a revolving movement at each movement of the rotating shaft by 6 degrees. Therefore, the gear 29 needs to be provided with a circumferential direction backlash amount in correspondence with jt since the gear 29 necessarily passes in a direction of operating the moment.

Hence, the invention is aimed for providing a reduction device at low cost capable of considerably alleviating restrictions placed on operation ranges of the respective shafts of a robot by providing the communication holes at center portions thereof and a wire-like member is arranged while using a main bearing having an optimum loading capacity, which is achieved by resolving a problem of minimizing a reduction in a backlash amount caused by a moment applied to the main bearing resulting in minimizing a backlash amount to be provided in advance.

### DISCLOSURE OF THE INVENTION

In order to achieve the above-described object, the invention 1 relates to a reduction device of an industrial robot having a robot base, a rotating barrel portion, a rotating shaft and a front/rear shaft. Further, the rotating shaft of said reduction device is characterized by a large gear with its position being fixed to the robot base, and a small gear which is axially supported in the rotating barrel portion and brought in mesh with the large gear, wherein the large gear and the small gear are arranged at a vicinity of a rotational plane of the front/rear shaft.

The invention 2 relates to a reduction device of an industrial robot having a robot base, a rotating barrel portion, a rotating shaft and a front/rear shaft. Moreover, the rotating shaft of the reduction device is characterized by a small gear axially supported by the robot base, and a large gear which is brought in mesh with the small gear with its position being fixed to the rotating barrel portion, wherein the large gear and the small gear are arranged at a vicinity of a rotational plane of the front/rear shaft.

The invention 3 relates to a reduction device of an industrial robot having a robot base, a rotating barrel portion, a rotating shaft and a front/rear shaft. Further, the front/rear shaft of the reduction device is characterized by a large gear with its position being fixed to a lower arm of the robot, a small gear which is axially supported in the rotating barrel portion and brought in mesh with the large gear, and an up/down shaft which is pivotably supported axially by the lower arm, wherein the large gear and the small gear are arranged at a vicinity of a plane passing a rotational center axis of the up/down shaft and in parallel with a rotational plane of the rotating shaft.

The invention 4 is characterized in including a through hole at a center portion of the large gear in the reduction device of an industrial robot described in the invention 1, 2 or 3.

As for the cases of the reduction devices of (1) through (3), they might be equivalent to a case in which the small gear is arranged at a position b shown in FIG. 7 and a moment is applied in a direction the same as a direction of connecting respective centers of the large gear and the small gear.

Therefore, a radius direction backlash jr is shown below when a width of the gear is designated by notation B and a fall angle of the gear is designated by notation θ.
jr=Bsinθ (2)

A relationship of the radius direction backlash jr with a circumferential direction backlash jt′ becomes as described below, assuming that α is a gear pressure angle (a gear pressure angle refers to an angle made by a radius line and a tangential line of a tooth shape at one point of a gear face).
jt′=2tanα×jr (3)

The backlash is reduced by said amount and when the pressure angle α is constituted by 14.5 degrees, Equation (3) becomes as follow.

$$\begin{matrix}{jt}^{′} = 2 tan 14.5 \times B sin θ \\ = 0.52 B sin θ\end{matrix} \qquad ( 4 )$$

From the above relation, it is found out that the backlash in circumferential direction provided to the gear should be about a half of that of the background art (1).

Next, when the small gear is arranged at a position c rotated from the position b by an angle β, a circumferential direction backlash jt″ is expressed as follows.

$$\begin{matrix}{jt}^{″} = B sin θ \times cos β + 2 tan α \times B sin θ sin β \\ = B sin θ ( cos β + 2 tan α \times B sin β ) \end{matrix} \qquad ( 5 )$$

When Y is put as follows and α is set to α=14.5 degrees, a relationship between Y and β becomes as shown by FIG. 10.
Y=cosβ30 2tanα×Bsinβ

Therefore, it is found that in a range of β from 0 to 0.61 rad (0 through 35 degrees) Y≦1, jt″ becomes smaller than jt.

Although the calculation example is for a spur gear, the same can be also employed for a helical gear or the like.

Next, according to the reduction device of an industrial robot as described in (4), the output stage becomes a constitution capable of reducing the backlash by using the gear train. Therefore, in comparison of the reduction device mechanism of a rotating type, a center portion is only provided with the communication hole where the main bearing having an optimum load capacity can be selected.

### BRIEF DESCRIPTION OF THE DRAWINGS

FIG. 1 is a side sectional view of an industrial robot according to the invention.

FIG. 2 is a front view of the industrial robot shown in FIG. 1.

FIG. 3 is a view showing Example 1 of the invention and is a sectional view taken along a line A-A of FIG. 1.

FIG. 4 is a view showing Example 2 of the invention and is a sectional view taken along a line B-B of FIG. 1.

FIG. 5 is an explanatory view with regard to a reduction in a backlash.

FIG. 6 is a side view showing a main work area of a robot.

FIG. 7 illustrates a sectional view (a) with regard to an arrangement of a small gear constituting an object of the invention and a perspective view (b) thereof.

FIG. 8 is a sectional view of an essential portion according to a reduction device 1 of a background art.

FIG. 9 is a sectional view according to a reduction device 2 of a background art.

FIG. 10 is a diagram with regard to an effect of reducing a backlash constituting a problem of the invention.

Further, numerical reference 3 in the drawings designates a load, numerical references 7, 7a designate motor shafts, numerical reference 10 designates a robot base, numerical reference 13 designates a rotating shaft motor, numerical references 22, 22a designate input small gears, numerical reference 23 designates a front/rear shaft motor, numerical references 25, 25a designate input large gears, numerical reference 29 designates a gear, numerical reference 30 designates a crankshaft, numerical references 33, 33a designate output shafts, numerical reference 42 designates a needle bearing, numerical references 84, 84a designate main bearings, numerical references 100, 100a designate large gears, numerical reference 102 designates a rotating barrel portion member, numerical references 103, 103a designate small gears, numerical reference 104 designates a rotating barrel portion member, numerical references 105, 105a designate bearings, numerical reference 115 designates a rotating barrel portion member, numerical reference 116 designates a rotating barrel portion member, notation AM1 designates a lower arm, notation AM2 designates an upper arm, and notation CB designates a cable (wire-like member).

### BEST MODE FOR CARRYING OUT THE INVENTION

Next, examples of the invention will be explained in reference to the drawings.

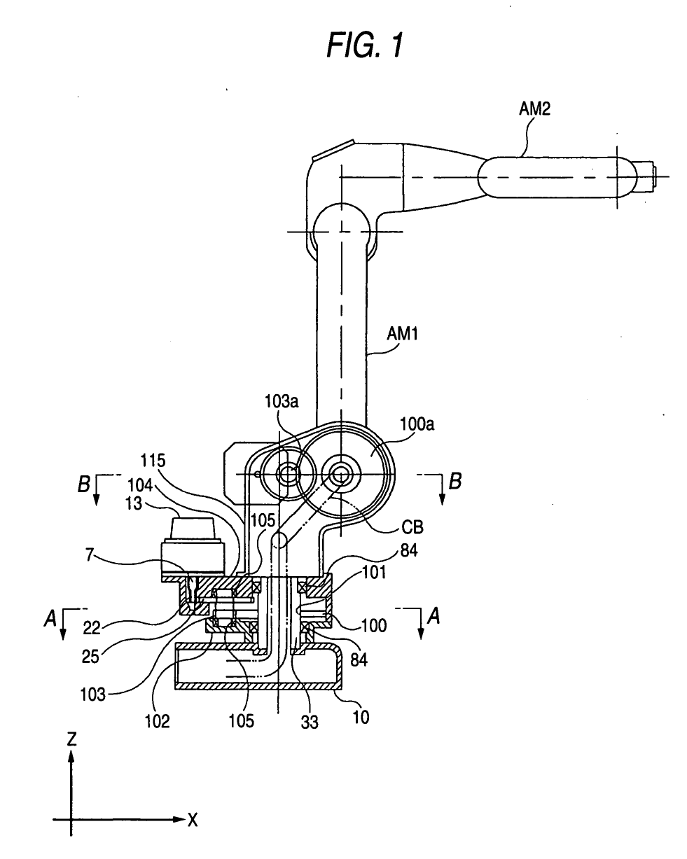

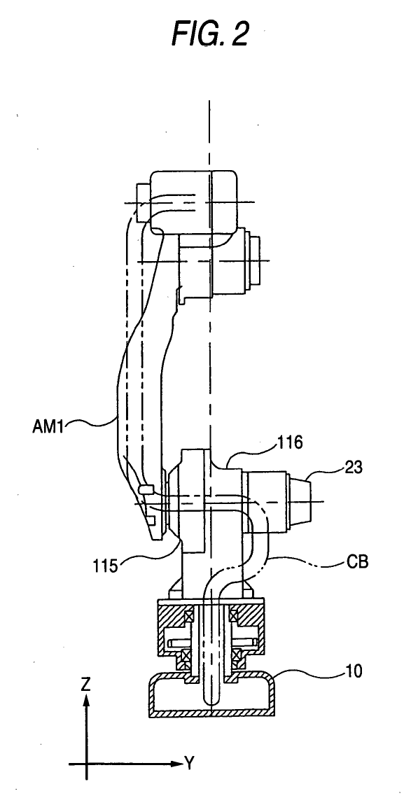

FIG. 1 and FIG. 2 are views for explaining a total of an industrial robot according to the invention, FIG. 1 is a side sectional view thereof, and FIG. 2 is a front view thereof. Both drawings show the invention 1 and the invention 4. Here, in order to enable to execute an operation of driving a rotating shaft, a speed of rotation of the rotating shaft motor 13 is reduced by the input small gear 22 and the input large gear 25 by way of the motor shaft 7. The small gear 103 is connected to the input large gear 25. The input large gear 25 is axially supported at the rotating barrel portion members 102, 104 by the bearings 105.

Further, there is constructed a constitution in which the input large gear 25 is brought in mesh with the large gear 100 supported by the robot base 10 and connected to the output shaft 33 to reduce the speed in two stages. The output shaft 33 and the large gear 100 may be integral with each other.

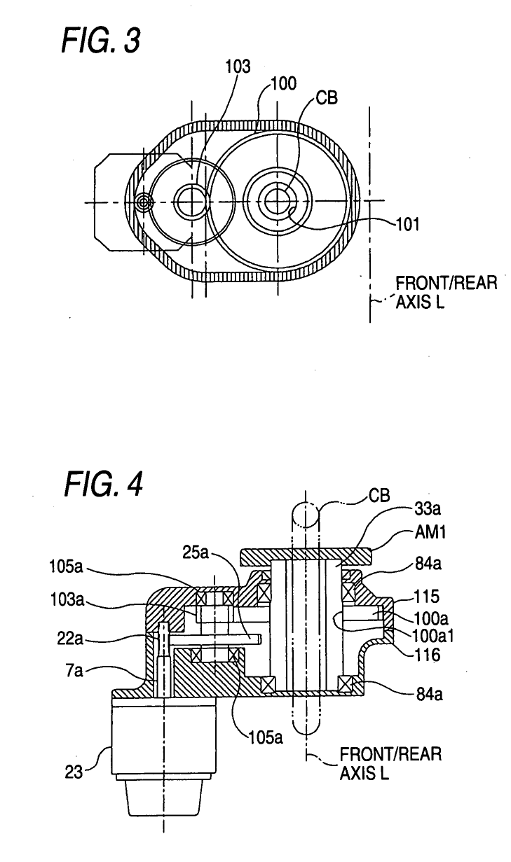

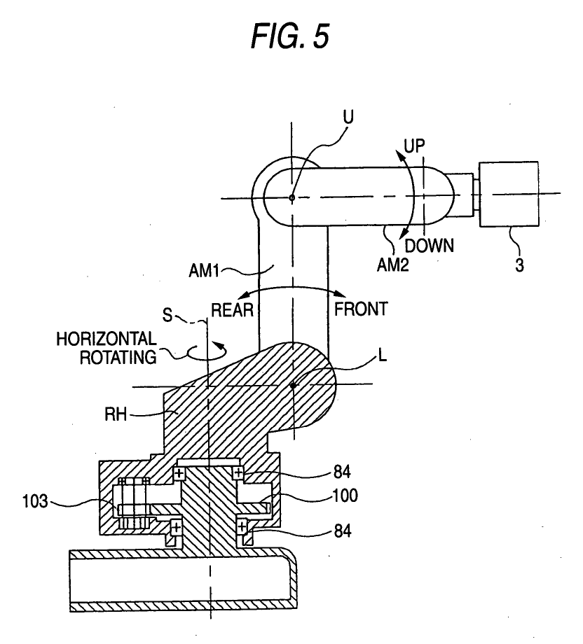

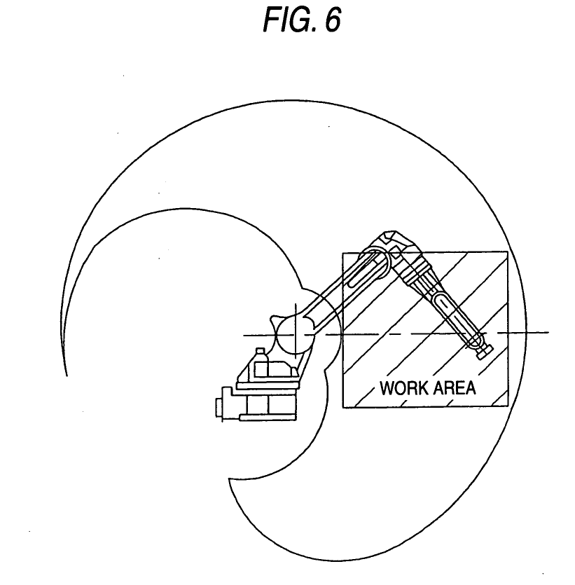

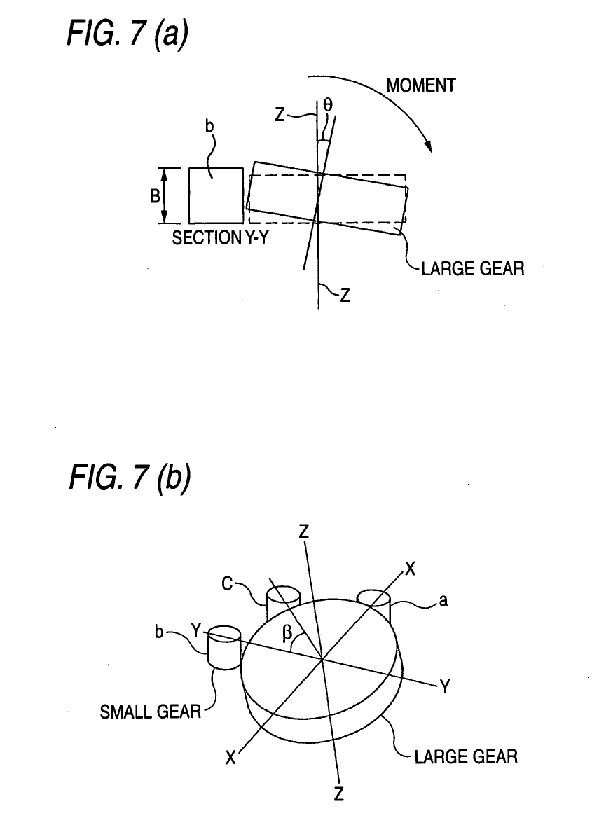

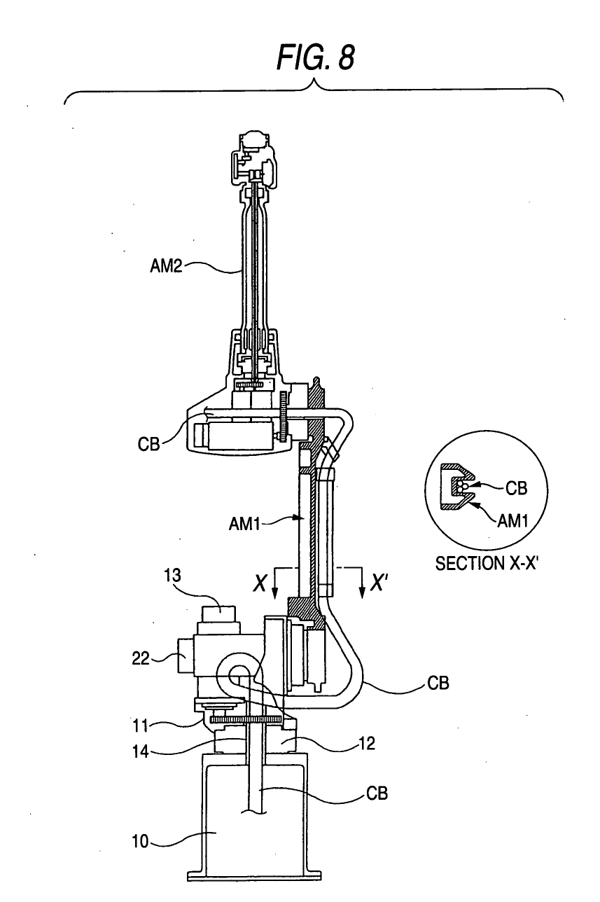

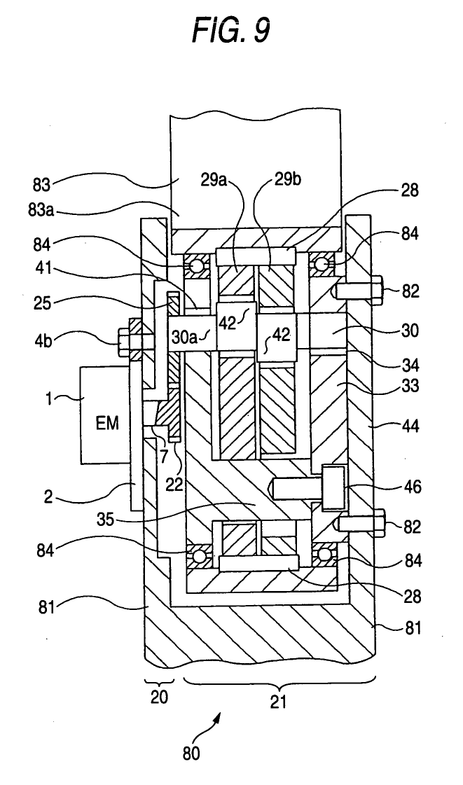

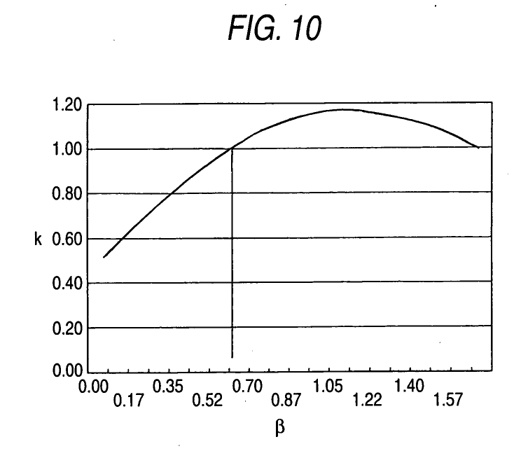

FIG. 3 is a view showing Example 1 and is a sectional view taken along a line A-A of FIG. 1. The drawing shows the invention 2 and the invention 4. As shown by the drawing, the large gear 100 and the small gear 103 are arranged orthogonally to a rotation center axis (illustrated by a one-dotted chain line) of a second shaft (front/rear shaft). An outer ring of the main bearing 84 (FIG. 1) is mounted to the rotating barrel portion members 102, 104, while an inner ring thereof is mounted to the output shaft 33 fixed to the robot base 10. In general, the main bearing 84 is constituted by a combination of two pieces thereof having the working angle opposed to each other, and when a moment load is applied thereto, inside of the main bearing is elastically deformed to produce a misalignment between a center of the inner ring and a center of the outer ring. Moments generated from the upper/lower shaft and the front/rear shaft change relative positions of the rotating barrel portion members 102, 104 relatively to the output shaft 33. The same can be said to a cross roller bearing for supporting a moment load by a single bearing. Therefore, since the small gear 103 is axially supported by the rotating barrel portion members 102, 104, an interval between axes of the large gear 100 and the small gear 103 is changed.

Now, since the moment is applied only to the plane including center lines of the small gear 103 and the large gear 100, therefore, the changing amount of the backlash in a circumferential direction occurring at the small gear 103 and the large gear 100 might be smaller than that of other arrangement. As to the rotational center of the small gear 103, it can be provided at any position within 35 degrees in a left and right direction centering on the large gear 100 in the plane including the center lines of the large gear 100 and the small gear 103 in order to achieve an effect of the invention. Although a gear train of the reduction device is constituted by two stages (input stage and output stage) the same can be employed for a gear train having three or more stages.

A center portion of the large gear 100 is opened with a communication hole 101 for arranging a wire-like member. Although in this case, the wire-like member is constituted by the cable CB for feeding electricity to a square shaft driving motor, a single piece of a wire-like member or two or more pieces of wire-like members including various cables or pipes of other object will do. In arranging such a wire-like member, any interference likely to happen in accordance with rotating are excluded. Further, an outer periphery of a hollow portion may be arranged only at the output shaft 33 for fixing the outer ring of the main bearing and therefore, a reduction in cost can be carried out since a necessary minimum bearing can be selected without being restricted by a dimension of the inner ring.

FIG. 4 is a view showing Example 2 and is a sectional view taken along a line B-B of Fib. 1. The drawing shows the invention 3 and the invention 4. In order to enable to operate the drive of the front/rear shaft, a speed of rotation of the front/rear shaft motor 23 is reduced by the input small gear 22a and the input large gear 25a by way of the motor shaft 7a. The small gear 103a is connected to the input gear 25a. The input large gear 25a is axially supported at the rotating barrel portion members 115, 116 by the bearings 105a. Further, the small gear 103a is constituted to be brought in mesh with the large gear 100a which is supported by the lower arm AM1 and connected to the output shaft 33a. The output shaft 33a and the large gear 100a may be integrated with each other.

As shown by FIG. 4, the large gear 100a and the small gear 25a are arranged in a plane in parallel with the rotating shaft rotating plane including a rotational center axis of the second shaft (front/rear shaft). An outer ring of main bearing 84a is mounted to the rotating barrel portion members 115, 116, and an inner ring thereof is mounted to the output shaft 33a fixed to the lower arm AM1. In general, the main bearing 84a is constituted by the combination of two pieces thereof having working angle opposed to each other and when the moment load is applied thereto, inside of the bearing is elastically deformed to produce a misalignment between a center of the inner ring and a center of the outer ring. A moment generated from operation of the rotating shaft changes relative positions of the rotating barrel portion members 115, 116 relatively to the output shaft 33a. Therefore, since the small gear 103a is axially supported by the rotating barrel portion members 115, 116, an interval between axes of the large gear 100a and the small gear 103a is changed. More overly, a moment is hardly generated or almost negligible value in the main bearing 84a by forces generated when the up/down shaft and the front/rear shaft are driven, or when the front/rear shaft and the up/down shaft remains stationary. This is because load distributions of the front/rear shaft and the up/down shaft are ordinarily disposed in an operating line of the main bearing 84a or at a vicinity thereof.

Now, since the moment is applied only around the plane including center lines of the small gear 103a and the large gear 100a, therefore, the changing amount of the backlash in a circumferential direction occurring at the large gear 100a and the small gear 103a might be smaller than that of other arrangement. As to the small gear 103a, it can be provided at any position within 35 degrees in a left and right direction in order to achieve an effect of the invention. Although a gear train of the reduction device is constituted by two stages (input stage and output stage), the same can be employed for a gear train having three or more stages.

A center portion of the large gear 100a is opened with a communication hole 100a1 for arranging a wire-like member. Concerning the wiring in such a structure, any interference likely to happen in accordance with rotating are excluded. Further, an outer periphery of a hollow portion may be arranged only at the output shaft 33a for fixing the outer ring of the main bearing and therefore, a reduction in cost can be carried out since a necessary minimum bearing can be selected without being restricted by a dimension of the inner ring.

### INDUSTRIAL APPLICABILITY

According to the invention 1 through the invention 3, a backlash amount to be previously provided in advance can be minimized by minimizing a reduction in a backlash amount caused by the moment applied to the main bearing. According to the constitution, even if the gear train is adopted at a final stage, the backlash becomes low. In case of employing the gear train, based on the invention 4, only the communication hole is present at the center portion of the main bearing so that a restriction on the range of operating each shaft of the robot can considerably be alleviated by arranging the wire-like member in the communication hole with allowing the main bearing to have the optimum load capacity. Further, the reduction device can be provided at low cost since the main bearing having the optimum capacity can be selected.

1. A reduction device of an industrial robot characterized in a reduction device of an industrial robot having a robot base installed in an XY plane of XYZ orthogonal coordinates, a rotating barrel portion rotatably attached to the robot base, and a lower arm of which one end is axially supported by the rotating barrel portion, which is a reduction device of an industrial robot including at least one stage of a gear train where a large gear fixed to the robot base and a small gear axially supported in the rotating barrel portion are brought in mesh with each other;
wherein the small gear is arranged by determining an angle of arranging the small gear, centering on a rotating shaft of the large gear within a range in which a circumferential direction backlash amount of the small gear becomes equal to or smaller than that of the large gear in a state of being inclined around an axis, which is connecting rotational centers of the large gear and the small gear in the XY plane owing to an operation of rotating the lower arm, in a state of arranging the small gear such that the axis passing the respective rotational center points of the large gear and the small gear in the XY plane is orthogonal to a plane of operating to rotate the lower arm.

2. A reduction device of an industrial robot characterized in a reduction device of an industrial robot having a robot base arranged in an XY plane of XYZ orthogonal coordinates, a rotating barrel portion rotatably attached to the robot base and a lower arm one end of which is axially supported by the rotating barrel portion, which is a reduction device of an industrial robot comprising at least one stage of a gear train at which a small gear axially supported by the robot base and a large gear fixed in the rotating barrel portion are brought in mesh with each other;
wherein the small gear is arranged by determining an angle of arranging the small gear centering on a rotating shaft of the large gear within a range in which a circumferential direction backlash amount of the small gear becomes equal to or smaller than a circumferential direction backlash amount when the large gear is inclined around an axis of connecting rotational centers of the large gear and the small gear in the XY plane owing to an operation of rotating the lower arm in a state of arranging the small gear such that the axis passing the respective rotational center points of the large gear and the small gear in the XY plane is orthogonal to a plane of operating to rotate the lower arm.

3. A reduction device of an industrial robot characterized in a reduction device of an industrial robot having a robot base installed in an XY plane of XYZ orthogonal coordinates, a rotating barrel portion;
rotatable attached to the robot base, a lower arm one end of which is axially supported by the rotating barrel portion, and an upper arm one end of which is axially supported by other end of the lower arm, which is a reduction device of an industrial robot comprising at least one stage of a gear train at which a large gear fixed to the lower arm and a small gear axially supported in the rotating barrel portion are brought in mesh with each other;
wherein the small gear is arranged by determining an angle of arranging the small gear centering on a rotating shaft of the large gear within a range in which a circumferential direction backlash amount of the small gear becomes equal to or smaller than a circumferential direction backlash amount when the large gear is inclined around an axis of connecting rotational centers of the large gear and the small gear in the XY plane owing to an operation of rotating the rotating barrel portion in a state of arranging the small gear such that the axis of passing the respective rotational center points of the large gear and the small gear in the XY plane becomes in parallel with a rotating shaft of the rotating barrel portion.

4. The reduction device of an industrial robot according to any one of claims 1 through 3, characterized in that the gear train of the reduction device is constituted by two stages.

5. The reduction device of an industrial robot according to any one of claims 1 through 3, characterized in that the gear train of the reduction device is constituted by one stage.

6. The reduction device of an industrial robot according to any one of claims 1 through 3, characterized in that a center portion of the large gear includes a communication hole.
